(19) United States
(12) Patent Application Publication
(10) Pub. No.: US 2016/0252239 A1
(43) Pub. Date: Sep. 1, 2016

(54) MAGNETIC ELECTRICAL TRACK

(71) Applicant: QTRAN, INC., Milford, CT (US)

(72) Inventors: John M. Tremaine, New Canaan, CT (US); Adrian R. Teschemaker, West Haven, CT (US)

(21) Appl. No.: 15/030,558

(22) PCT Filed: Oct. 20, 2014
(86) PCT No.: PCT/US14/61327

§ 371 Date: Apr. 19, 2016

Related U.S. Application Data
(60) Provisional application No. 62/007,469, filed on Jun. 4, 2014.

(51) Int. Cl. F21V 21/34; F21V 23/00; F16L 3/26; F21V 21/096

(52) U.S. Cl. CPC F21V 21/34; F21V 21/096; F21V 23/002; F16L 3/26; F21Y 2103/003

(57) ABSTRACT

Exemplary embodiments of the present invention are directed to a magnetic electrical track that includes a track portion and one or more magnets attached to the track portion. The track portion includes a channel configured to receive the one or more magnets, a pair of slots and a raceway. The pair of slots may extend from one end of the track portion to the other end, and are configured to receive and retain one or more lighting fixtures. The raceway may also extend from one end of the track portion to the other end, and may be configured so as to receive and retain any conductors that may be accompanying the lighting fixtures. The one or more magnets may be secured to the track portion by one or more fasteners, and the track portion may include a threaded channel configured to receive the one or more fasteners.

### CROSS-REFERENCE TO RELATED APPLICATIONS

This application is based on and/or relates to U.S. Provisional Appl. No. 62/007,469 filed Jun. 4, 2014, which is hereby incorporated by reference in its entirety.

### BACKGROUND OF THE INVENTION

1. Field of the Invention

The present invention generally relates to a magnetic electrical track, and more particularly relates to a positionable and adjustable magnetic electrical track configured to support and retain lighting and accompanying conductors.

2. Description of Related Art

Track lighting is a popular form of lighting that provides some flexibility for positioning and/or adjustment of lighting fixtures. However, track lighting must be secured to a structure in order prior to installation and/or adjustment of the lighting fixtures. Accordingly, once installed the lighting fixtures attached to the track lighting are limited to the length of track that has been installed. Furthermore, it may be difficult or problematic to install the track lighting in certain location or on certain materials. For example, installation of track lighting onto metal surfaces may require significant man hours to prepare the surfaces by drilling appropriate holes and then installing the track lighting to such surfaces. Once installed, it may require even more time to reposition and/or remove the track lighting to a different or more desirable location. Accordingly, what is needed is a system that allows for efficient installation and movement of lighting systems.

### SUMMARY OF THE INVENTION

The present invention is designed to overcome the above noted limitations that are attendant upon the use of conventional track lighting and, toward this end, it contemplates the provision of a novel magnetic electrical track.

It is an object of the present invention to provide a magnetic electrical track that can efficiently be installed to ferrous metal structures.

It is another object of the present invention to provide a magnetic electrical track that can be repositioned or removed without significant effort or damage to the structure.

It is yet another object of the present invention to provide a magnetic electrical track that is configured to retain and/or support one or more light fixtures or light emitting diode (LED) tape and the accompanying conductors.

It is still another object of the present invention to provide a magnetic electrical track that is configured to securely affix one or more light fixtures to a building structure.

It has now been found that the foregoing and related objects can be readily attained in a magnetic electrical track that includes a track portion and one or more magnets attached to the track portion. The track portion includes a channel configured to receive the one or more magnets, a pair of slots and a raceway. The pair of slots may extend from one end of the track portion to the other end, and are configured to receive and retain one or more lighting fixtures. The raceway may also extend from one end of the track portion to the other end, and may be configured so as to receive and retain any conductors that may be accompanying the lighting fixtures. The one or more magnets may be secured to the track portion by one or more fasteners, and the track portion may include a threaded channel configured to receive the one or more fasteners.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is an isometric view of an exemplary magnetic electrical track according to the present invention;

FIG. 2 is an isometric exploded view of the exemplary magnetic electrical track according to the present invention;

FIG. 3 is a front view of the exemplary magnetic electrical track according to the present invention;

FIG. 4 is an isometric view of another exemplary magnetic electrical track according to the present invention;

FIG. 5 is an isometric exploded view of the other exemplary magnetic electrical track according to the present invention; and

FIG. 6 is a front view of the other exemplary magnetic electrical track according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

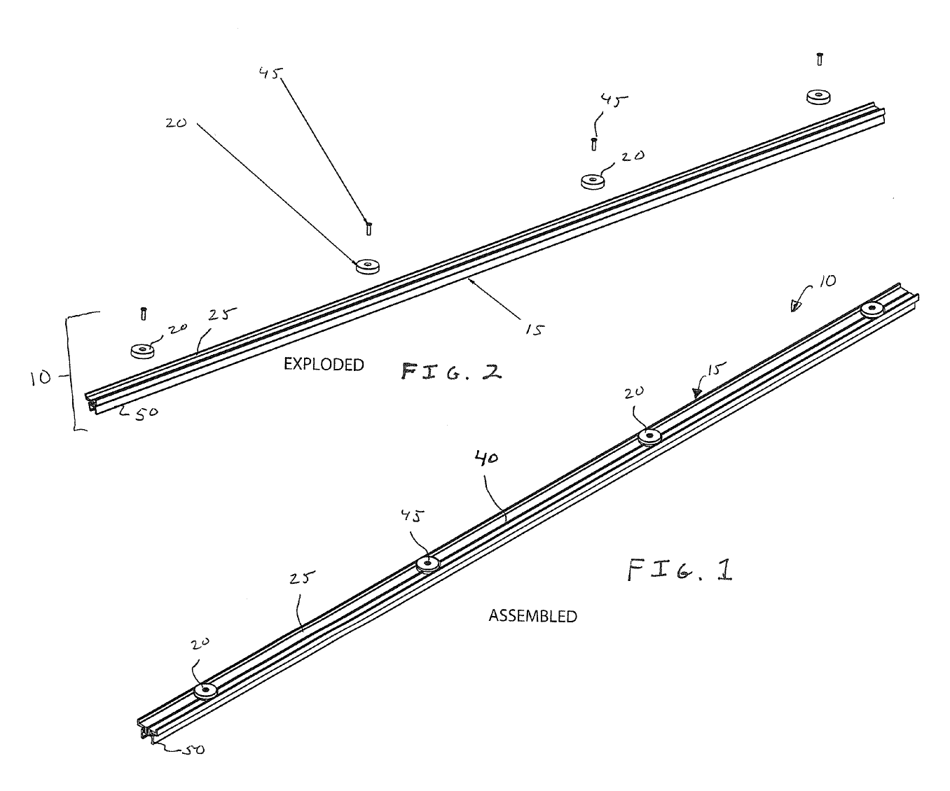

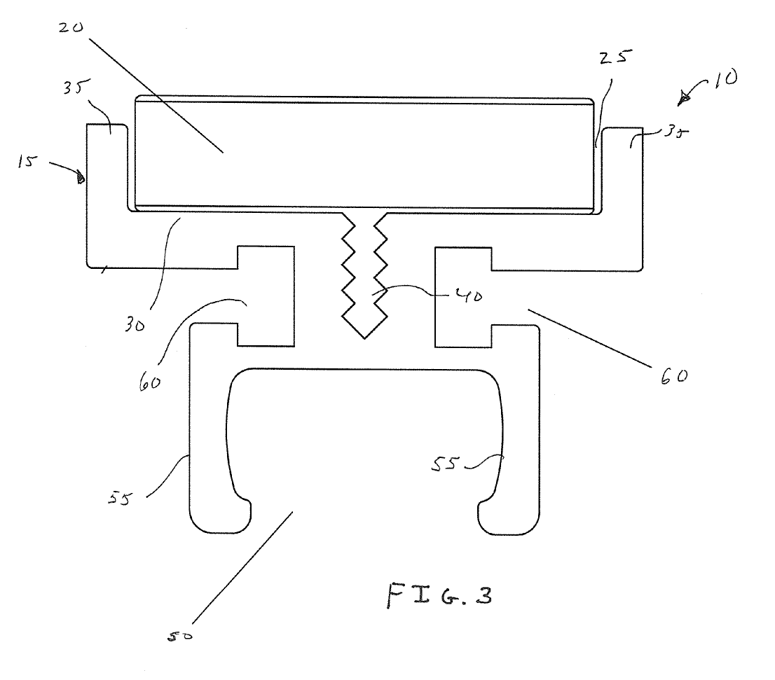

Referring now to FIGS. 1-3, therein illustrated is an exemplary embodiment of a magnetic electrical track, generally indicated by reference numeral 10, according to the present invention. The magnetic electrical track 10 is configured to hold one or more electrical fixtures, such as track lighting or a light emitting diode strip, and the accompanying conductors to a structure containing a ferrous metal. For example, the magnetic electrical track 10 can be removably secured to a ferrous metal structural member of the structure. The magnetic electrical track 10 includes a track 15, which may be formed from an extrusion, for example an aluminum extrusion, and one or more magnets 20. The track 15 may include a top channel 25 that is dimensioned so as to receive the one or more magnets 20 at any point along the length of the magnetic electrical track 10. It is understood that the one or more magnets 20 may have any suitable shape for receipt within the top channel 25, and may be for example, round, oblong, rectangular, diamond-shaped and/or square. The top channel 25 includes a base 30 and a pair of longitudinal upright walls 35 running parallel to either other along the length of the track 15. Preferably, the longitudinal upright walls 35 may have a height that is less than the height of the one or more magnets 20 so that the longitudinal upright walls 35 do not interfere with the surface on which the magnets 20 may be affixed to. The track 15 of the magnetic electrical track 10 may also include a threaded channel 40 running along the length of the track 15, and configured to receive one or more fasteners 45, for example flat head screws, in order to secure the one or more magnets 20 to the track 15. Preferably, the one or more fasteners 45 secure the one or more magnets 20 to the track 15 through a countersunk bore formed in each of the one or more magnets 20, so that the head of each of the fasteners 45 is flush with or below the surface of the magnets 20 opposite the base 30 of the track 15. It is understood that the one or more magnets 20 are positionable at any point along the length of the track 15, as a result of the threaded channel 40 extending the entire length of the track 15. However, it is understood that the threaded channel 40 does not need to be contiguous, and/or may be replaced by one or more threaded bores (not shown) formed within the track 15.

Still referring to FIGS. 1-3, the track 15 of the magnetic electrical track 10 may also include a raceway 50 running substantially parallel to the top channel 25 along the length of the track 15. The raceway 50 may be configured and dimensioned so as to receive one or more conductors (not shown) of an electrical lighting fixture that may be secured to the magnetic electrical track 10, as discussed further below. The raceway 50 may include a pair of opposed longitudinal tongs 55 running the length of the raceway 50. The longitudinal tongs 55 are configured so as to retain and/or secure the one or more conductors (not shown) within the raceway 50. The track 15 of the magnetic electrical track 10 may further include a pair of opposing slots 60 formed on opposite sides of the track 15 and positioned between the top channel 25 and the raceway 50. The slots 60 are configured to receive and hold a light fixture that may be slide onto the track 15 of the magnetic electrical track 10. The light fixture (not shown) may be slid onto either end of the track 15, and then positioned at any suitable location along the track 15. The slots 60 in cooperation with the raceway 50 provide for a means for moving the light fixtures along the track 15, while at the same time supporting the light fixtures so that the light fixtures can only be separated from the track 15 at the ends of the track 15.

The operation, use and functionality of the magnetic electrical track 10 will now be discussed with respect to FIGS. 1-3. It is understood that the magnetic electrical track 10 may be removably and adjustably secured to any surface made from a ferrous metal. It is further understood that the magnetic electrical track 10 may have light fixtures and accompanying conductors, e.g. wiring, installed thereon prior to affixing the magnetic electrical track 10 to its desired location, or that the light fixtures and accompanying conductors may be installed once the magnetic electrical track 10 has been affixed to its desired location. Furthermore, the magnetic electrical track 10 may be adjusted and/or repositioned after it has been affixed to its desired location by either sliding the magnetic electrical track 10 along the ferrous metal that the magnetic electrical track 10 is affixed to, or by simply removing the magnetic electrical track 10 and reaffixing it to the ferrous metal at another location. The track 15 and or the magnets 20 may be painted or powder coated in order to enhance the appearance and/or durability of the magnetic electrical track 10.

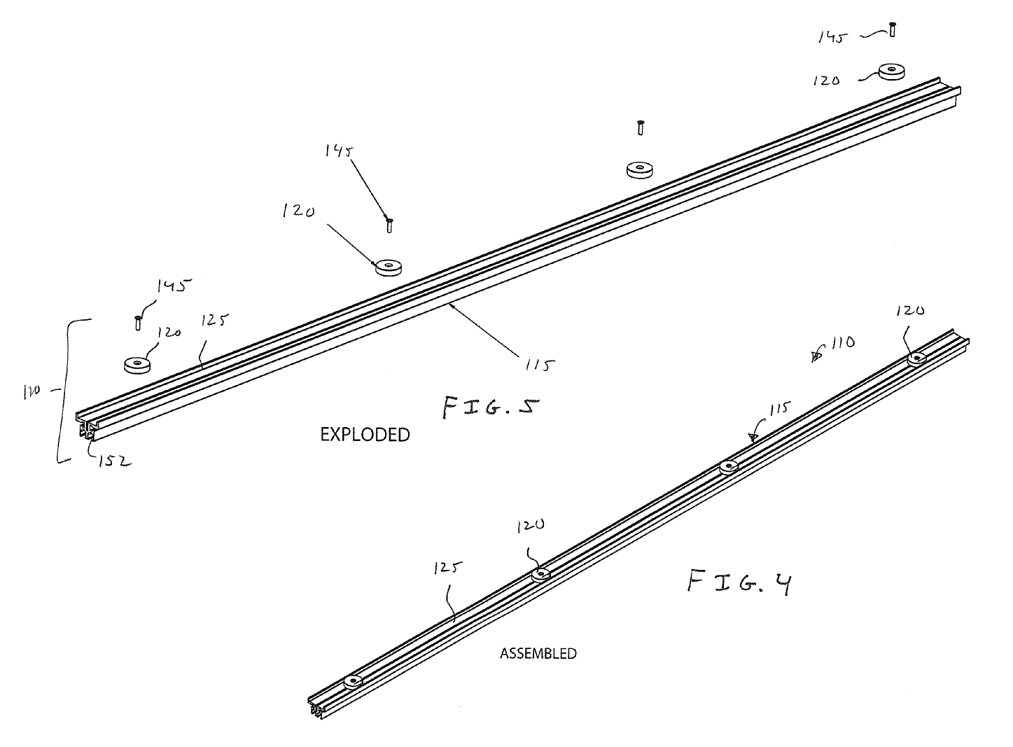

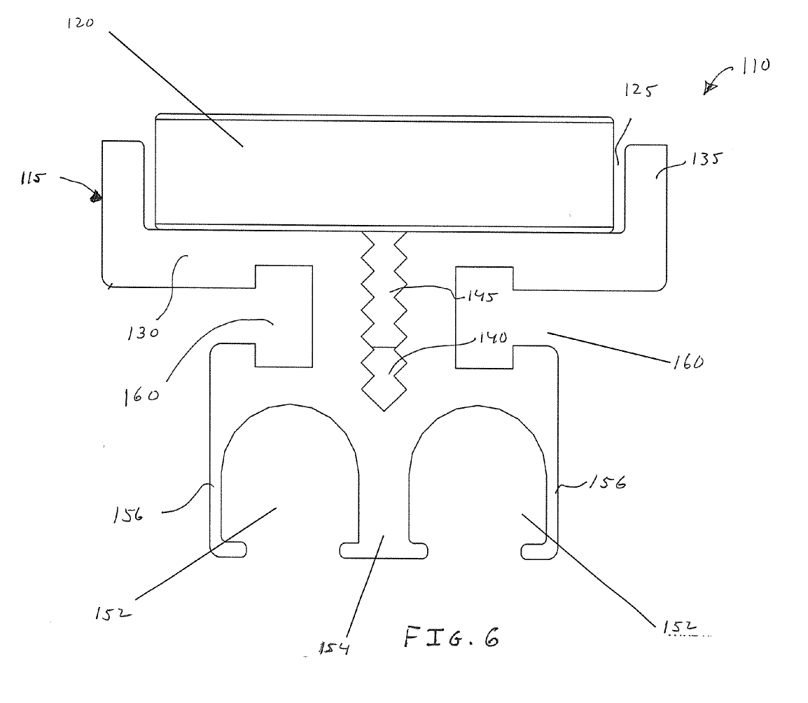

Referring now to FIGS. 4-6, therein illustrated is an alternative exemplary embodiment of a magnetic electrical track, generally indicated by reference numeral 110, according to the present invention. The magnetic electrical track 110 is configured to hold one or more electrical fixtures, such as track lighting or a light emitting diode strip, and the accompanying conductors to a structure containing a ferrous metal. For example, the magnetic electrical track 110 can be removably secured to a ferrous metal structural member of the structure. The magnetic electrical track 110 includes a track 115, which may be formed from an extrusion, for example an aluminum extrusion, and one or more magnets 120. The track 115 may include a top channel 125 that is dimensioned so as to receive the one or more magnets 120 at any point along the length of the magnetic electrical track 110. It is understood that the one or more magnets 120 may have any suitable shape for receipt within the top channel 125, and may be for example, round, oblong, rectangular, diamond-shaped and/or square. The top channel 125 includes a base 130 and a pair of longitudinal upright walls 135 running parallel to either other along the length of the track 115. Preferably, the longitudinal upright walls 135 may have a height that is less than the height of the one or more magnets 120 so that the longitudinal upright walls 135 do not interfere with the surface on which the magnets 120 may be affixed to. The track 115 of the magnetic electrical track 110 may also include a threaded channel 140 running along the length of the track 115, and configured to receive one or more fasteners 145, for example flat head screws, in order to secure the one or more magnets 120 to the track 115. Preferably, the one or more fasteners 145 secure the one or more magnets 120 to the track 115 through a countersunk bore formed in each of the one or more magnets 120, so that the head of each of the fasteners 145 is flush with or below the surface of the magnets 120 opposite the base 130 of the track 115. It is understood that the one or more magnets 120 are positionable at any point along the length of the track 115, as a result of the threaded channel 140 extending the entire length of the track 115. However, it is understood that the threaded channel 140 does not need to be contiguous, and/or may be replaced by one or more threaded bores (not shown) formed within the track 115.

Still referring to FIGS. 4-6, the track 115 of the magnetic electrical track 110 may also include one or more wire raceways 152 running substantially parallel to the top channel 125 along the length of the track 115. The wire raceways 152 may be configured and dimensioned so as to each receive one conductor (not shown) of an electrical lighting fixture that may be secured to the magnetic electrical track 110, as discussed further below. Each wire raceway 152 is separated from another wire raceway 152 by a divider 154 positioned between the wire raceways 152. It is understood that more than two wire raceways 152 may be included in the track 115, and that an appropriate number of dividers 154 will then be included in order to adequately separate the wire raceways 152. The outer wire raceways 152 are closed off by a pair of opposed longitudinal tongs 156 running the length of the wire raceways 152. The longitudinal tongs 156 are configured so as to retain and/or secure the conductors (not shown) in cooperation with the divider 154 within the respective wire raceway 152. It is understood that by providing individual wire raceways 152 for each conductor (not shown) bending the conductors, for example at 90° turn, is facilitated since individual conductor strands may be used. The track 115 of the magnetic electrical track 110 may further include a pair of opposing slots 160 formed on opposite sides of the track 115 and positioned between the top channel 125 and the wire raceways 152. The slots 160 are configured to receive and hold a light fixture that may be slide onto the track 115 of the magnetic electrical track 110. The light fixture (not shown) may be slid onto either end of the track 115, and then positioned at any suitable location along the track 115. The slots 160 in cooperation with the wire raceways 152 provide for a means for moving the light fixtures along the track 115, while at the same time supporting the light fixtures so that the light fixtures can only be separated from the track 115 at the ends of the track 115.

The operation, use and functionality of the magnetic electrical track 110 will now be discussed with respect to FIGS. 4-6. It is understood that the magnetic electrical track 110 may be removably and adjustably secured to any surface made from a ferrous metal. It is further understood that the magnetic electrical track 110 may have light fixtures and accompanying conductors, e.g. wiring, installed thereon prior to affixing the magnetic electrical track 110 to its desired location, or that the light fixtures and accompanying conductors may be installed once the magnetic electrical track 110 has been affixed to its desired location. Furthermore, the magnetic electrical track 110 may be adjusted and/or repositioned after it has been affixed to its desired location by either sliding the magnetic electrical track 110 along the ferrous metal that the magnetic electrical track 110 is affixed to, or by simply removing the magnetic electrical track 110 and reaffixing it to the ferrous metal at another location. The track 115 and or the magnets 120 may be painted or powder coated in order to enhance the appearance and/or durability of the magnetic electrical track 110.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

1. An electrical track, comprising:
a track portion having a first side and a second side that opposes the first side, wherein the first side comprises a channel formed therein and the second side comprises at least one raceway disposed therein;
at least one magnet at least partially disposed within the channel of the first side of the track portion; and
at least one slot formed in the track portion and positioned between the first side and the second side of the track portion.

2. The electrical track according to claim 1, wherein the track portion further comprises a first end and a second end, and wherein the at least one slot extends along the track portion from the first end to the second end.

3. The electrical track according to claim 1, further comprising a groove formed within the channel on the first side of the track portion, and wherein the groove is configured to receive at least one fastener to secure the at least one magnet to the first side of the track portion.

4. The electrical track according to claim 1, wherein the at least one slot has a substantially T-shaped configuration.

5. The electrical track according to claim 1, wherein the at least one raceway comprises a pair of tongs each having a rib extending from the tong towards an interior region of the at least one raceway.
